(19) United States
(12) Patent Application Publication
(10) Pub. No.: US 2023/0215101 A1
(43) Pub. Date: Jul. 6, 2023

(54) METHOD, DEVICE, AND NON-TRANSITORY COMPUTER-READABLE RECORDING MEDIUM TO CREATE 3D OBJECT FOR VIRTUAL SPACE

(71) Applicant: LINE Plus Corporation, Seongnam-si (KR)

(72) Inventor: Sol E CHOI, Seongnam-si (KR)

(73) Assignee: LINE Plus Corporation, Seongnam-si (KR)

(21) Appl. No.: 18/145,452

(22) Filed: Dec. 22, 2022

(30) Foreign Application Priority Data
Jan. 5, 2022 (KR) 10-2022-0001804

(51) Int. Cl. G06T 19/00; G06T 15/00

(52) U.S. Cl. CPC G06T 19/00; G06T 15/00; G06T 2200/24

(57) ABSTRACT

A method, a device, and a non-transitory computer-readable recording medium for creating a three-dimensional (3D) object for a virtual space that may create a 3D object by three-dimensionally rendering an object extracted from an input image, may set a design element of the 3D object in association with a virtual space in which an avatar is provided, and may provide the 3D object to which the design element is applied as an item of the virtual space.

### CROSS-REFERENCE TO RELATED APPLICATION(S)

This U.S. non-provisional application and claims the benefit of priority under 35 U.S.C. § 119 to Korean Patent Application No. 10-2022-0001804, filed Jan. 5, 2022, the entire contents of which are incorporated herein by reference in their entirety.

### BACKGROUND

### Technical Field

Some example embodiments of the following description relate to technology for creating an object to be used as an item of a virtual space.

### Related Art

An instant messenger that is a typical communication tool refers to software that allows users to send and receive messages or data in real time. A user may register a conversation contact in a contact list of the instant messenger and may exchange messages in real time with a counterpart using the instant messenger.

Such a messenger function is common in a mobile environment of a mobile communication terminal as well as a personal computer (PC).

As the use of an instant messenger becomes popular and functions provided through the instant messenger become more diversified, provided is a service in which a user may create an avatar that is a character replacing a role of the user and may photograph and share an avatar desired by the user.

### SUMMARY

Some example embodiments may create an object extracted from a directly drawn picture or a photo as a three-dimensional (3D) object available as an item of a virtual space.

Some example embodiments may set a size, a position, a motion, and a texture of a 3D object in association with a virtual space in which an avatar is provided.

According to an aspect of at least one example embodiment, there is provided a method of inserting a three-dimensional (3D) object as an item within a virtual space using a computer device including at least one processor configured to execute computer-readable instructions included in a memory.

In some example embodiments, the method includes creating, by the at least one processor, the 3D object by three-dimensionally rendering an object extracted from an image; setting, by the at least one processor, a design element of the 3D object in association with the virtual space, the virtual space including an avatar of a user; and inserting, by the at least one processor, the 3D object to which the design element is applied as the item within the virtual space.

In some example embodiments, the method further includes displaying, by the at least one processor, the 3D object and the avatar within the virtual space; and editing, by the at least one processor, the 3D object in response to a user selection from an edit menu within a home screen associated with the virtual space.

In some example embodiments, the method includes the creating, by the at least one processor, includes extracting the object from the image input through a camera or stored in the memory.

In some example embodiments, the extracting, by the at least one processor, includes detecting an output or a feature point of the object in the image through an object detection algorithm.

In some example embodiments, the creating, by the at least one processor, includes specifying an object type according to a selection of the user; and extracting the object from the image using an attribute corresponding to the object type.

In some example embodiments, the creating, by the at least one processor, includes providing a plurality of 3D model previews of different designs; and creating the 3D object using one of the plurality of 3D model previews selected by a user.

In some example embodiments, the design element includes one or more of a size, a position, a motion, and a texture of the 3D object, and the setting, by the at least one processor, and the method further includes setting the design element and an effect of the 3D object in the virtual space.

In some example embodiments, at least one of the size and the position of the 3D object is set based on the avatar in the virtual space.

In some example embodiments, the setting, by the at least one processor, includes differently configuring and providing an option for setting the design element according to the object type.

In some example embodiments, the setting, by the at least one processor, includes providing a list of motions applicable to the 3D object as the design element; and providing a preview in which a motion selected from the list of motions is applied to the 3D object.

Some example embodiments relate to a non-transitory computer-readable recording medium storing instructions that, when executed by the at least one processor, causes the at least one processor to computer-implement the method of inserting a three-dimensional (3D) object as an item within a virtual space.

Some example embodiments relate to a computer device.

In some example embodiments, the computer device includes at least one processor configured to execute computer-readable instructions included in a memory to configure the computer device to insert a three-dimensional (3D) object as an item within a virtual space by, creating the 3D object by three-dimensionally rendering an object extracted from an image, setting a design element of the 3D object in association with the virtual space, the virtual space including an avatar of a user, and inserting the 3D object to which the design element is applied as the item within the virtual space.

In some example embodiments, the at least one processor is configured to, display the 3D object and the avatar within the virtual space, and edit the 3D object in response to a user selection from an edit menu within a home screen associated with the virtual space.

In some example embodiments, the at least one processor is configured to extract the object from the image input through a camera or stored in the memory.

In some example embodiments, the at least one processor is configured to, specify an object type according to a selection of a user, and extract the object from the image using an attribute corresponding to the object type.

In some example embodiments, the at least one processor is configured to, provide a plurality of 3D model previews of different designs, and create the 3D object using one of the plurality of 3D model previews selected by the user.

In some example embodiments, the design element includes one or more of a size, a position, a motion, a texture, and an effect of the 3D object in the virtual space.

In some example embodiments, at least one of the size and the position of the 3D object is based on the avatar in the virtual space.

In some example embodiments, the at least one processor is configured to differently configure and provide an option for setting the design element according to the object type.

In some example embodiments, the at least one processor is configured to, provide a list of motions applicable to the 3D object as the design element, and provide a preview in which a motion selected from the list of motions is applied to the 3D object.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

FIG. 1 is a diagram illustrating an example of a network environment according to at least one example embodiment;

FIG. 2 is a diagram illustrating an example of a computer device according to at least one example embodiment;

FIG. 3 is a flowchart illustrating an example of a method performed by a computer device according to at least one example embodiment;

FIG. 4 illustrates an example of an avatar service home screen according to at least one example embodiment;

FIG. 5 illustrates an example of an object type selection screen according to at least one example embodiment; and

FIGS. 6 to 11 illustrate examples of a process of creating a three-dimensional (3D) object and providing the 3D object in a virtual space according to at least one example embodiment.

### DETAILED DESCRIPTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Hereinafter, some example embodiments will be described with reference to the accompanying drawings.

The example embodiments relate to technology for creating a three-dimensional (3D) object to be used as an item of a virtual space.

The example embodiments including the disclosures herein may create a 3D object available as an item of a virtual space in which an avatar is provided using a picture or a photo.

An avatar item creation system according to some example embodiments may be implemented by at least one computer device. An avatar item creation method according to some example embodiments may be performed by at least one computer device included in the avatar item creation system. Here, a computer program according to an example embodiment may be installed and run on the computer device and the computer device may perform the avatar item creation method according to example embodiments under control of the computer program. The aforementioned computer program may be stored in a non-transitory computer-readable recording medium to implement the avatar item creation method in conjunction with the computer device.

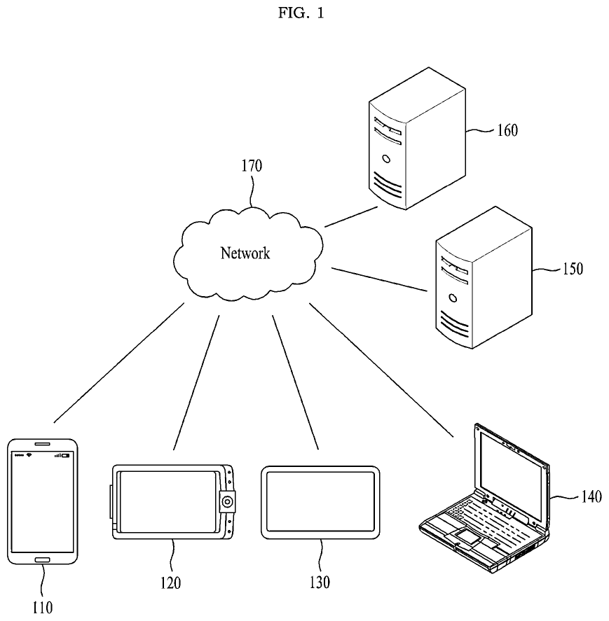

FIG. 1 illustrates an example of a network environment according to at least one example embodiment.

Referring to FIG. 1, the network environment may include a plurality of electronic devices 110, 120, 130, and 140, a plurality of servers 150 and 160, and a network 170.

FIG. 1 is provided as an example only. A number of electronic devices or a number of servers is not limited thereto. Also, the network environment of FIG. 1 is provided as one example of environments applicable to the example embodiments and an environment applicable to the example embodiments is not limited to the network environment of FIG. 1.

Each of the plurality of electronic devices 110, 120, 130, and 140 may be a fixed terminal or a mobile terminal that is configured as a computer device. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet PC, and the like. For example, although FIG. 1 illustrates a shape of a smartphone as an example of the electronic device 110, the electronic device 110 used herein may refer to one of various types of physical computer devices capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, and a broadcasting network.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer device or a plurality of computer devices that provides an instruction, a code, a file, content, a service, etc., through communication with the plurality of electronic devices 110, 120, 130, and 140 over the network 170. For example, the server 150 may be a system that provides a service, for example, an avatar service, to the plurality of electronic devices 110, 120, 130, and 140 connected over the network 170.

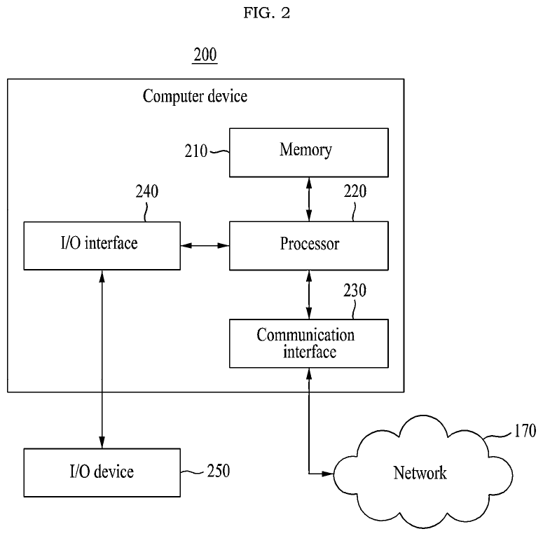

FIG. 2 is a block diagram illustrating an example of a computer device according to at least one example embodiment. Each of the plurality of electronic devices 110, 120, 130, and 140 or each of the servers 150 and 160 may be implemented by a computer device 200 of FIG. 2.

Referring to FIG. 2, the computer device 200 may include a memory 210, a processor 220, a communication interface 230, and an input/output (I/O) interface 240. The memory 210 may include a permanent mass storage device, such as a random access memory (RAM), a read only memory (ROM), and a disk drive, as a non-transitory computer-readable recording medium. The permanent mass storage device, such as a ROM and a disk drive, may be included in the computer device 200 as a permanent storage device separate from the memory 210. Also, an OS and at least one program code may be stored in the memory 210. Such software components may be loaded to the memory 210 from another non-transitory computer-readable recording medium separate from the memory 210. The other non-transitory computer-readable recording medium may include, for example, a floppy drive, a disk, a tape, a DVD/CD-ROM drive, a memory card, etc. According to other example embodiments, software components may be loaded to the memory 210 through the communication interface 230, instead of the non-transitory computer-readable recording medium. For example, the software components may be loaded to the memory 210 of the computer device 200 based on a computer program installed by files received over the network 170.

The processor 220 may be configured to process instructions of a computer program by performing basic arithmetic operations, logic operations, and I/O operations. The computer-readable instructions may be provided by the memory 210 or the communication interface 230 to the processor 220. For example, the processor 220 may be configured to execute received instructions in response to a program code stored in a storage device, such as the memory 210.

The communication interface 230 may provide a function for communication between the communication device 200 and another apparatus, for example, the aforementioned storage devices. For example, the processor 220 of the computer device 200 may forward a request or an instruction created based on a program code stored in the storage device such as the memory 210, data, and a file, to other apparatuses over the network 170 under control of the communication interface 230. Inversely, a signal, an instruction, data, a file, etc., from another apparatus may be received at the computer device 200 through the communication interface 230 of the computer device 200. For example, a signal, an instruction, data, etc., received through the communication interface 230 may be forwarded to the processor 220 or the memory 210, and a file, etc., may be stored in a storage medium, for example, the permanent storage device, further includable in the computer device 200.

The I/O interface 240 may be a device used for interfacing with an I/O device 250. For example, an input device may include a device, such as a microphone, a keyboard, a mouse, etc., and an output device may include a device, such as a display, a speaker, etc. As another example, the I/O interface 240 may be a device for interfacing with an apparatus in which an input function and an output function are integrated into a single function, such as a touchscreen. The I/O device 250 may be configured as a single apparatus with the computer device 200. The display may include a graphical user interface (GUI) that displays various screens generated by the processor 220 to the user.

Also, according to other example embodiments, the computer device 200 may include a greater or smaller number of components than the number of components of FIG. 2. However, there is no need to clearly illustrate many conventional components. For example, the computer device 200 may be configured to include at least a portion of the I/O device 250 or may further include other components, such as a transceiver and a database.

Hereinafter, example embodiments of a method and apparatus for creating a 3D object for a virtual space are described.

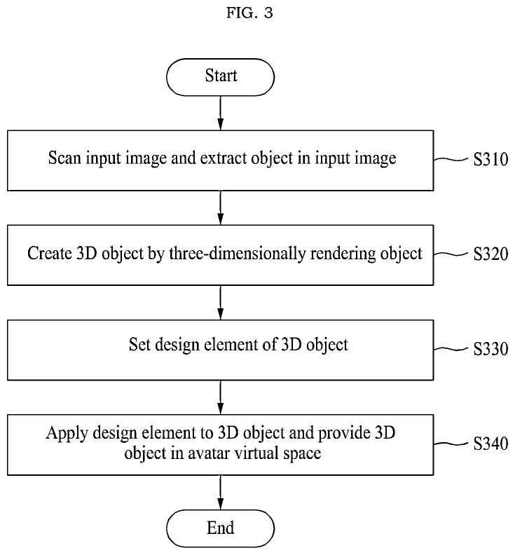

FIG. 3 is a flowchart illustrating an example of a method performed by a computer device according to at least one example embodiment.

Referring to FIGS. 2 and 3, the computer device 200 according to the example embodiments may provide a client with an avatar service through connection to a dedicated application installed on the client or a website/mobile site related to the computer device 200. An avatar item creation system implemented as a computer may be configured in the computer device 200. For example, the avatar item creation system may be implemented in a form of a program that independently operates or may be implemented in an in-app form of a specific application, for example, a messenger, to be operable on the specific application.

The processor 220 of the computer 200 may be implemented as a component for performing the avatar item creation method of FIG. 3. Depending on example embodiments, the components of the processor 220 may be optionally included in or excluded from the processor 220. Also, depending on example embodiments, the components of the processor 220 may be separated or merged for functional expressions of the processor 220.

The processor 220 and the components of the processor 220 may control the computer device 200 to perform operations 5310 to 5340 included in the avatar item creation method of FIG. 3. For example, the processor 220 and the components of the processor 220 may be implemented to execute instructions according to a code of at least one program or a code of an OS included in the memory 210.

The processor 220 may be one example of processing circuitry used to control the computer device 200. The processing circuitry may including logic circuits or a hardware/software combination such as the processor 220 executing software stored on the memory 210. For example, the processing circuitry more specifically may include, but is not limited to, a central processing unit (CPU), an arithmetic logic unit (ALU), a digital signal processor, a microcomputer, a field programmable gate array (FPGA), a programmable logic unit, a microprocessor, application-specific integrated circuit (ASIC), etc.

The processor 220 may be transformed into a special purpose processor trough execution of the instructions to insert a 3D object 632, 1032 within a virtual space 410 that includes an avatar 411 of a user by capturing a 2D image a scene in the real world that includes the object, extracting the object from the captured 2D image using, for example, attributes associated with a selected object type input by the user, create the 3D object 632, 1032 by performing a 3D rendering of the extracted object, setting various design elements of the generated 3D object, and inserting the designed 3D object 632, 1032 within the virtual space 410 at a set position relative to the avatar 411 of the user. Therefore, the processor 220 may improve the functioning of the instant messenger by allowing the user to easily customize an avatar to include a 3D object.

Here, the components of the processor 220 may be representations of different functions performed by the processor 220 according to an instruction provided from a program code stored in the computer device 200.

The processor 220 may read a necessary instruction from the memory 210 to which instructions related to control of the computer device 200 are loaded. In this case, the read instruction may include an instruction for controlling the processor 220 to perform the following operations 5310 to 5340.

The following operations 5310 to 5340 may be performed in order different from illustrated order of FIG. 3 and a portion of operations 5310 to 5340 may be omitted or an additional process may be further included.

Referring to FIG. 3, in operation 5310, the processor 220 may scan (or, alternatively, capture) an input image and extract an object in the input image. The processor 220 may provide a function (hereinafter, an item creation function) of creating a 3D object as one of functions for editing an avatar virtual space configured as a home screen of an avatar service. The processor 220 may create a 3D object available as an item of the avatar virtual space using a picture directly drawn by a user or a photo presented by the user. In response to a request for executing the item creation function from the user, the processor 220 may activate a camera and may receive a photo or a picture captured in a focus area of the camera as a two-dimensional (2D) image. The processor 220 may extract the object in the corresponding image through an object detection algorithm for detecting an outline or a feature point of the 2D image, such as a photo input through the camera or stored in the memory 210 or a picture input from the user.

In a process in which the user executes the item creation function, an object type may be specified and a preset that includes an outline or an attribute for object detection may be differently defined according to the object type. For example, the object type may include all types of items that may be provided in the virtual space with an avatar, for example, pets, furniture, home appliances, interior accessories, tableware, groceries, and clothes. The. processor 220 may detect an object of a corresponding type from the 2D image input through the camera using a preset corresponding to the object type specified by the user.

In operation 5320, the processor 220 may create a 3D object by three-dimensionally rendering the object extracted from the input image. The processor 220 may create the 3D object through 3D modeling for a 2D object image. The processor 220 may model the 3D object with 3D graphics that implements a 3D effect of a cross-section or a 3D effect of omni-directions for the 2D object. For example, the processor 220 may create the 3D object with a common design through a preset 3D model. As another example, the processor 220 may provide a plurality of 3D models of different designs as a customable design option and may create a 3D object with a design of a corresponding 3D model using the 3D model specified by the user from among the plurality of 3D models.

In operation 5330, the processor 220 may set a design element of the 3D object as a user setting option for providing the 3D object in the avatar virtual space. The design element of the 3D object may include a size, a position, a motion (movement), a texture, and an effect of the 3D object. The processor 220 may adjust a size of the 3D object to a size desired by the user based on the avatar provided in the virtual space. The processor 220 may set a position of the 3D object as the position desired by the user based on the avatar provided in the virtual space, for example, between “in front of the avatar” and “behind the avatar.” Here, the processor 220 may adjust a detailed position of the 3D object through a user input, such as a drag within a position set based on the avatar. The processor 220 may provide a plurality of motion sets applicable to the 3D object and may set a motion specified by the user from among the plurality of motion sets as a motion of the 3D object. A different motion set may be configured according to the object type and an applicable motion may vary according to the object type. For example, a motion applicable to a pet and a motion applicable to furniture may be differently defined. The processor 220 may set a 3D texture, such as a color, density, or a pattern desired by the user, to be applied to a graphic surface of the 3D object. The processor 220 may provide a plurality of texture sets applicable to the 3D object and may set a texture specified by the user from among the plurality of texture sets as a texture of the 3D object. Likewise, a preset texture set may be differently configured according to the object type and an applicable 3D texture may vary according to the object type.

In operation 5340, the processor 220 may apply a design element according to a user setting to the 3D object and may provide (or, alternatively, insert) the 3D object as an item in the virtual space in which the avatar is provided. The processor 220 may provide the 3D object created based on the picture directly drawn by the user or the photo presented by the user with the avatar as the item in the virtual space according to an option desired by the user.

Therefore, the processor 220 may produce the 3D object using the picture directly drawn by the user or the photo presented by the user, and may adjust the 3D object to a size, a position, a motion, or a texture desired by the user through a setting option for providing the 3D object in the avatar virtual space.

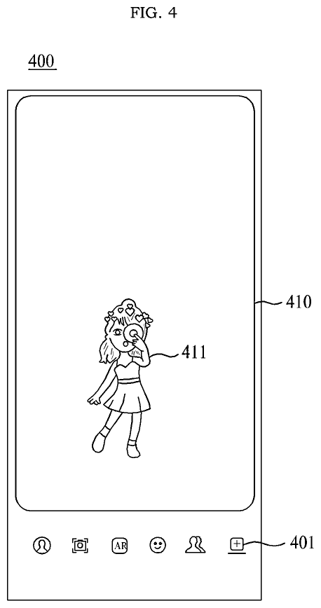

FIG. 4 illustrates an example of an avatar service home screen according to at least one example embodiment.

Referring to FIG. 4, when accessing an avatar service, the processor 220 may provide an avatar service home screen 400. Here, the avatar service home screen 400 may be configured as a virtual space 410 in which an avatar 411 is provided.

The avatar service home screen 400 may include an “edit” menu 401 for editing the virtual space 410 as one of home menus and may create a 3D object applicable as an item of the virtual space 410 as an editing function for the virtual space 410.

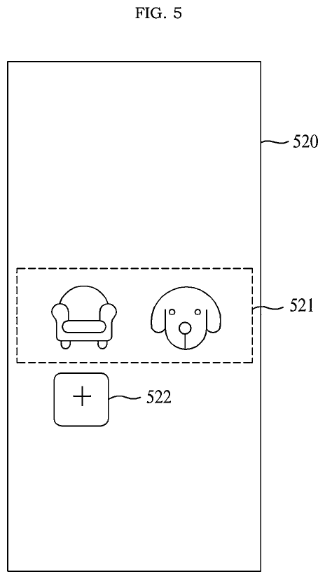

FIG. 5 illustrates an example of an object type selection screen according to at least one example embodiment.

Referring to FIG. 5, in response to a selection on the “edit” menu 401 on the avatar service home screen 400, the processor 220 may provide an object type selection screen 520.

The object type selection screen 520 may include an object type list 521 as an interface screen for selecting a type (a category) of a 3D object that the user desires to produce.

The object type may correspond to an item type providable in the virtual space 410 with the avatar 411, such as pets, furniture, home appliances, interior accessories, groceries, and clothes, and a preset for object detection may be predefined for each object type.

The processor 220 may configure and provide an object type list 521 as an object type selected as a setting option by the user. The object type selection screen 520 may further include an “add” menu 522 for additionally registering an object type to the object type list 521.

The object type selection screen 520 may provide an interface capable of configuring and editing the object type list 521 with an object type desired by the user.

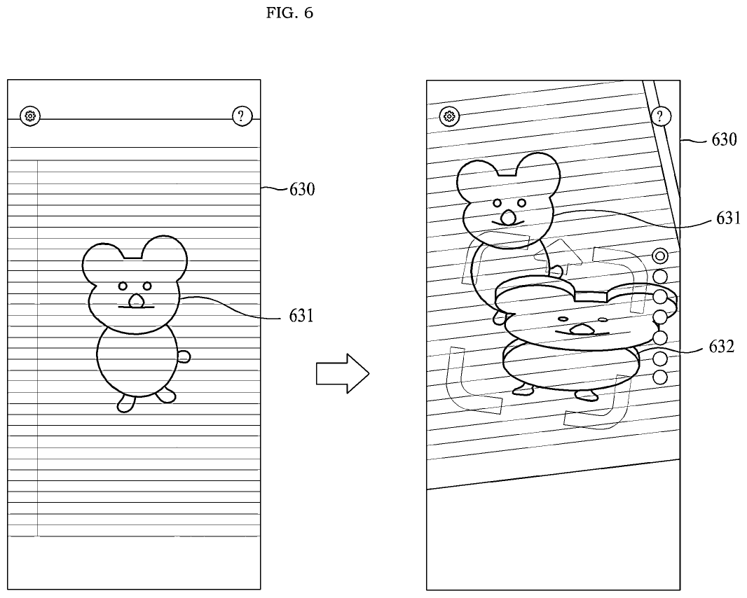

FIGS. 6 to 11 illustrate examples of a process of creating a 3D object and providing the created 3D object in a virtual space according to at least one example embodiment.

Referring to FIG. 6, in response to a selection on a specific object type from the object type list 521 of the object type selection screen 520, the processor 220 may activate a camera and may capture a camera video 630.

The user may adjust a picture directly drawn by the user to be captured by the camera. Here, the processor 220 may extract an object 631 drawn by the user from an image input through the camera video.

The processor 220 may detect the object 631 of a corresponding type from the camera video 630 using a preset corresponding to the object type selected by the user.

For example, when the user selects “pet” from the object type list 521, the processor 220 may extract the animal-shaped object 631 from the camera video 630 using a method of detecting an outline or a feature point of an animal shape using a preset corresponding to “pet.”

The processor 220 may create the object 631 detected from the camera video 630 into a 3D object 632 by three-dimensionally rendering the object 631. Here, the processor 220 may provide the 3D object 632 as augmented reality (AR) content in the camera video 630.

When 3D modeling is customizable according to a user setting, the processor 220 may provide 3D model previews of different designs for the 3D object 632 and may use the 3D object 632 of a design selected by the user through a preview as a final result.

When the user desires to provide the 3D object 632 as an item of the virtual space 410 after user confirmation on the 3D object 632 is completed, the processor 220 may provide an interface for setting a design element of the 3D object 632.

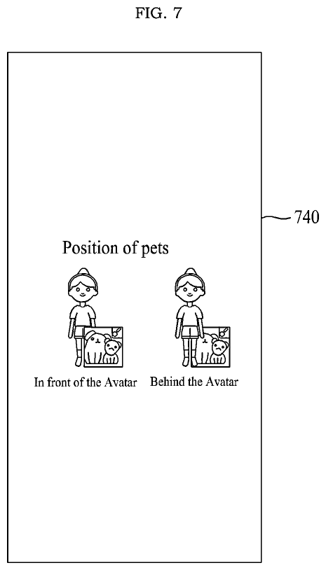

Referring to FIG. 7, the processor 220 may provide a position setting screen 740 for setting a position of the 3D object 632.

The user may set, as a default position of the 3D object 632, a position of the 3D object 632 that is provided in front of the avatar 411 or behind the avatar 411 in the virtual space 410 through the position setting screen 740.

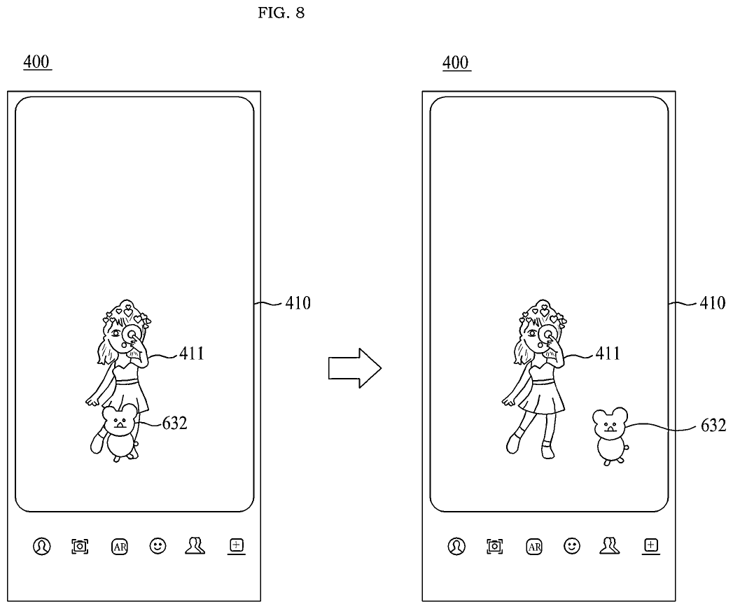

Referring to FIG. 8, when the default position of the 3D object 632 is set through the position setting screen 740, the processor 220 may provide the 3D object 632 as the item within the virtual space 410 and, here, may provide the 3D object 632 based on the default position that is set based on the avatar 411 of the virtual space 410.

In response to a user input, such as a drag gesture, in a state in which the 3D object 632 is provided in the virtual space 410, the processor 220 may change the position of the 3D object 632 in the virtual space 410. That is, the processor 220 may move and adjust a detailed position of the 3D object 632 under a default position condition that is set based on the avatar 411 in the virtual space 410.

In response to a user input, such as a pinch gesture, in a state in which the 3D object 632 is provided in the virtual space 410, the processor 220 may adjust the size of the 3D object 632.

In addition to the position or the size of the 3D object 632, the processor 220 may provide an interface for setting a motion of the 3D object 632.

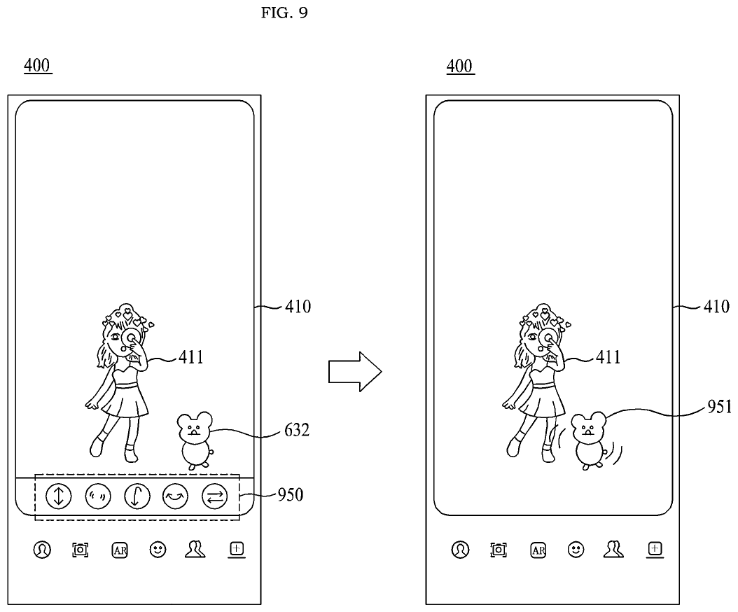

Referring to FIG. 9, for example, in response to a long-tap on the 3D object 632 in a state in which the 3D object 632 is provided in the virtual space 410, the processor 220 may provide a motion selection option 950. However, example embodiments are not limited thereto.

The motion selection option 950 may include a list of motions applicable to the 3D object 632 and, in response to a selection on a motion included in the list of motions, may provide a preview 951 to which the motion is applied to the 3D object 632.

The motion selection option 950 may include a different motion list according to an object type selected through the object type selection screen 520.

The processor 220 may provide an interface for setting a texture, such as a color, intensity, or a pattern of the 3D object 632.

For example, in response to a long-tap on the 3D object 632 in a state in which the 3D object 632 is provided in the virtual space 410, the processor 220 may provide a texture selection option and may set a texture selected by the user as a texture of the 3D object 632 through the texture selection option.

The processor 220 may create a 3D object of a different type in addition to the animal-shaped 3D object 632 and may provide the created 3D object as an item of the virtual space 410.

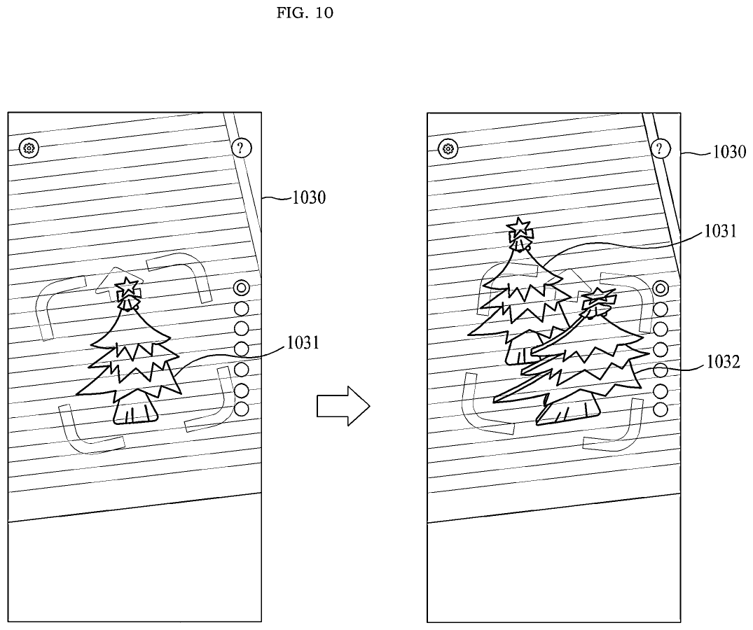

Referring to FIG. 10, for example, in response to a selection on “interior accessories” from the object type list 521 from the user, the processor 220 may extract an object 1031 having a set (or, alternatively, present) shape captured within a camera video 1030 using the preset corresponding to “interior accessories.”

The processor 220 may create an 3D object 1032 by three-dimensionally rendering the object 1031 detected from the camera video 1030 and may provide the 3D object 1032 as AR content in the camera video 1030.

When the user desires to provide the 3D object 1032 as an item of the virtual space 410 after user conformation on the 3D object 1032 is completed, the processor 220 may provide an interface for setting a design element of the 3D object 1032.

Referring to FIG. 7, the processor 220 may provide the position setting screen 740 for setting a position of the 3D object 1032. The user may set, as a default position of the 3D object 1032, a position of the 3D object 1032 that is provided in front of the avatar 411 or behind the avatar 411 in the virtual space 410 through the position setting screen 740.

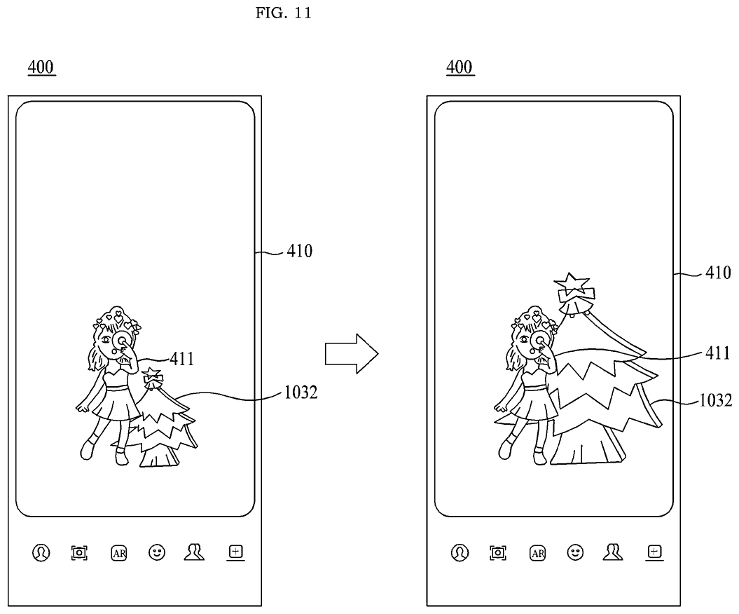

Referring to FIG. 11, when the default position of the 3D object 1032 is set through the position setting screen 740, the processor 220 may provide the 3D object 1032 as the item within the virtual space 410 and, here, may provide the 3D object 1032 at the default position that is set based on the avatar 411 in the virtual space 410.

In response to a user input, such as a drag gesture, in a state in which the 3D object 1032 is provided in the virtual space 410, the processor 220 may move and change a position of the 3D object 1032 in the virtual space 410.

In response to a user input, such as a pinch gesture, in a state in which the 3D object 1032 is provided in the virtual space 410, the processor 220 may adjust a size of the 3D object 1032.

The processor 220 may provide an interface for setting a motion, a texture, an effect, etc., of the 3D object 1032 in addition to a position or a size of the 3D object 1032.

For example, in response to a long-tap on the 3D object 1032 in a state in which the 3D object 1032 is provided in the virtual space 410, the processor 220 may provide a motion or texture selection option and may apply an option selected by the user as the design element of the 3D object 1032.

Therefore, the processor 220 may edit the virtual space 410 that is an avatar service home screen by providing the 3D object 632, 1032 created based on the picture directly drawn by the user as the item in the virtual space 410 with the avatar 411 according to the option desired by the user.

According to some example embodiments, it is possible to create an object extracted from a directly drawn picture or a photo as a 3D object available as an item of a virtual space, and to set a size, a position, a motion, a texture, an effect, etc., of the 3D object in association with the virtual space in which an avatar is provided.

The apparatuses described above may be implemented using hardware components, software components, and/or a combination thereof. For example, the apparatuses and the components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For simplicity, the description of a processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, a computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable storage mediums.

The methods according to some example embodiments may be configured in a form of program instructions performed through various computer methods and recorded in non-transitory computer-readable media. The media may continuously store computer-executable programs or may temporarily store the same for execution or download. Also, the media may be various types of recording devices or storage devices in a form in which one or a plurality of hardware components are combined. Without being limited to media directly connected to a computer device, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include recording media and storage media managed by an app store that distributes applications or a site, a server, and the like that supplies and distributes other various types of software.

While this disclosure includes specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, other implementations, other example embodiments, and equivalents are within the scope of the following claims.

What is claimed is:

1. A method of inserting a three-dimensional (3D) object as an item within a virtual space using a computer device including at least one processor configured to execute computer-readable instructions included in a memory, the method comprising:
creating, by the at least one processor, the 3D object by three-dimensionally rendering an object extracted from an image;
setting, by the at least one processor, a design element of the 3D object in association with the virtual space, the virtual space including an avatar of a user; and
inserting, by the at least one processor, the 3D object to which the design element is applied as the item within the virtual space.

2. The method of claim 1, further comprising:
displaying, by the at least one processor, the 3D object and the avatar within the virtual space; and
editing, by the at least one processor, the 3D object in response to a user selection from an edit menu within a home screen associated with the virtual space.

3. The method of claim 1, wherein the creating, by the at least one processor, comprises:
extracting the object from the image input through a camera or stored in the memory.

4. The method of claim 3, wherein the extracting, by the at least one processor, comprises:
detecting an output or a feature point of the object in the image through an object detection algorithm.

5. The method of claim 1, wherein the creating, by the at least one processor, comprises:
specifying an object type according to a selection of the user; and
extracting the object from the image using an attribute corresponding to the object type.

6. The method of claim 1, wherein the creating, by the at least one processor, comprises:
providing a plurality of 3D model previews of different designs; and
creating the 3D object using one of the plurality of 3D model previews selected by the user.

7. The method of claim 1, wherein the design element includes one or more of a size, a position, a motion, and a texture of the 3D object, and the setting, by the at least one processor, further comprises:
setting the design element and an effect of the 3D object in the virtual space.

8. The method of claim 7, wherein at least one of the size and the position of the 3D object is set based on the avatar in the virtual space.

9. The method of claim 5, wherein the setting, by the at least one processor, comprises:
differently configuring and providing an option for setting the design element according to the object type.

10. The method of claim 1, wherein the setting, by the at least one processor, comprises:
providing a list of motions applicable to the 3D object as the design element; and
providing a preview in which a motion selected from the list of motions is applied to the 3D object.

11. A non-transitory computer-readable recording medium storing instructions that, when executed by the at least one processor, causes the at least one processor to computer-implement the method of claim 1.

12. A computer device, comprising:
at least one processor configured to execute computer-readable instructions included in a memory to configure the computer device to insert a three-dimensional (3D) object as an item within a virtual space by,
creating the 3D object by three-dimensionally rendering an object extracted from an image,
setting a design element of the 3D object in association with the virtual space, the virtual space including an avatar of the user, and
inserting the 3D object to which the design element is applied as the item within the virtual space.

13. The computer device of claim 12, wherein the at least one processor is configured to,
display the 3D object and the avatar within the virtual space, and
edit the 3D object in response to a user selection from an edit menu within a home screen associated with the virtual space.

14. The computer device of claim 12, wherein the at least one processor is configured to extract the object from the image input through a camera or stored in the memory.

15. The computer device of claim 12, wherein the at least one processor is configured to,
specify an object type according to a selection of the user, and
extract the object from the image using an attribute corresponding to the object type.

16. The computer device of claim 12, wherein the at least one processor is configured to,
provide a plurality of 3D model previews of different designs, and
create the 3D object using one of the plurality of 3D model previews selected by the user.

17. The computer device of claim 12, wherein the design element includes one or more of a size, a position, a motion, a texture, and an effect of the 3D object in the virtual space.

18. The computer device of claim 17, wherein at least one of the size and the position of the 3D object is based on the avatar in the virtual space.

19. The computer device of claim 15, wherein the at least one processor is configured to differently configure and provide an option for setting the design element according to the object type.

20. The computer device of claim 12, wherein the at least one processor is configured to,
provide a list of motions applicable to the 3D object as the design element, and
provide a preview in which a motion selected from the list of motions is applied to the 3D object.
